(19) United States
(12) Patent Application Publication
(10) Pub. No.: US 2009/0255023 A1
(43) Pub. Date: Oct. 15, 2009

(54) SURGICAL AND MEDICAL GARMENTS AND MATERIALS INCORPORATING SHEAR THICKENING FLUIDS

(76) Inventors: T. Haydn Williams, Cambridge (GB); Jonathan Day, Lancashire (GB); Simon Pickard, Cheshire (GB)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/440,086

(22) PCT Filed: Sep. 3, 2007
(86) PCT No.: PCT/GB07/03310

§ 371 Date: Apr. 27, 2009

(30) Foreign Application Priority Data
Sep. 5, 2006 (GB) 0617452.8

(51) Int. Cl. F41H 1/02; B05D 1/02; B05D 1/18; A41D 13/12; A41D 19/00; A41D 13/00

(52) U.S. Cl. 2/2.5; 427/2.3; 427/2.31; 2/114; 2/161.7; 2/9

(57) ABSTRACT

A surgical garment in the form of a surgical gown, a surgical glove or a surgical mask incorporates a shear thickening fluid as a layer on at least one of the inner and outer surface of the garment, the viscosity of which shear thickening fluid increases to inhibit penetration of the garment.

The present invention relates to surgical garments and materials such as surgical gowns, surgical gloves, wound-care products and the like which include shear thickening fluids so to increase their puncture resistance.

Shear Thickening Fluids or STFs are a class of fluids whose viscosity is temporarily or reversibly increased upon application of a shear force thereto or upon exposing the fluid to an electric charge or magnetic field, which causes the magneto-rheological particles suspended within the fluid to change their orientation and increase the viscosity. The effect, however induced, dissipates and the fluid returns to its normal viscosity upon removal of the inducement.

STFs are varied in nature and composition. Generally STFs all exhibit characteristic flow behaviour which can be described as non-newtonian and are characterised by a large increase in viscosity with increasing shear stress. They generally consist of dispersions of colloidal particles of size less than 100 microns in diameter within various media. Suitable particles include silicon dioxide, calcium carbonate, nanoparticles of various other polymers including albeit not exclusively poly(styrene), poly(methylmethacrylate), or blends thereof. The dispersion media is either aqueous or alcoholic in nature and includes ethylene glycol, poly(ethylene glycol) or silicon based polymerics. Surfactants may also be included within the formulation to aid stability of such dispersions. The materials that comprise the liquid affect the properties of the STF although do not necessarily determine the properties exhibited by the fluid. Other properties such as the particle size and distribution of the particle size of the fluid and the concentration of the particles within the fluid determine the properties the fluid exhibit.

STFs have found application in a wide variety of technologies including fluid coupling devices for gearboxes, vehicle suspension systems etc. It has also been taught to use STFs in body armour to increase the penetration resistance to impact from high speed objects such as bullets whilst maximising flexibility of the armour and reducing weight—the low viscosity of the STF in its rest state allowing flexing of the armour whilst the immediate increase in viscosity due to the very high shear forces induced upon the impact of a bullet providing effect dissipation of the energy of the impacting article and thereby preventing penetration.

According to the present invention there is provided a surgical garment or material which includes an STF which operates to inhibit penetration of the garment or material.

A surgical garment or material in accordance with the invention has the advantage that the low viscosity of the STF in its normal or rest state ensures that it does not increase the overall flexibility of the garment or material and hence does not hinder the wearer's free movement or the wearers tactile sensation, which is important for example if the wearer is a surgeon performing a surgical procedure. Furthermore, it is preferred that STF be light weight so that the addition of the STF does not have any appreciable effect on the weight of the garment or material. On the other hand, however, the variable viscosity properties of the STF increases the piercing resistance for example by a needle or other sharp instrument, thereby providing improved protection to the wearer.

Surgical garments suitable for implementation of the invention include, but are not limited to surgical gowns, surgical gloves, surgical masks and the like, and may be manufactured using a wide range of known techniques, for example, in the case of surgical gloves, by dipping, spraying etc. Furthermore, conventional materials may be employed to produce the ‘fabric’ of the article, such as natural rubber latex, de-proteinised natural rubber latex, synthetic latices based on various chemical formulation etc. in the case of gloves.

Shear thickening fluids may then be incorporated either additionally, or alternatively, within or coated onto the surfaces of the article via any of the following routes:
Fully formed article dipped in shear thickening fluid;
Article dipped in shear thickening fluid at an intermediate stage of the manufacturing process;
Applied to the article outer surface
Applied to the article inner surface
Applied at an intermediate stage of article manufacture so as to be present between both the inner and outer surfaces of the article;
Application may be effected by a range of application techniques including dipping and spraying.
Fully formed article sprayed with shear thickening fluid;
Article to which shear thickening fluid has been applied at an intermediate stage of the manufacturing process;

In a development of the invention, a single layer of ballistic resistant material (BRM) e.g. Kevlar may be used between the inner and outer layers of the article construction, with said BRM being impregnated with the shear thickening material.

The use of a individual fibres of ballistic resistant material (BRM) e.g. Kevlar dispersed within shear thickening fluid at a point between the inner and outer layers of the article construction is also a possibility, with said BRM being either impregnated or not impregnated with the shear thickening material. The Shear Thickening Fluid-BRM matrix being applied in such a manner as to effectively create a membrane system with application of the BRM being achieved either via dipping, spraying or other conventional manufacture methods on either the outer, inner, both or between such surfaces.

Dyestuffs or other coloured media may also advantageously to be added to the colloidal dispersions of shear thickening fluids so as to provide a meaningful indication of when the glove surface has been breached. This effect can also be achieved by incorporating the shear thickening fluid in a composite article comprising translucent and coloured layers in such a way that the coloured layers become more apparent on puncture.

The shear thickening fluid may be contained between the inner and outer surface of the article, thus forming a form of membrane structure, being present within the membrane in the form of either a solution or a gel, potentially with particulates of BRM's also dispersed within the membrane structure. The shear thickening fluids may also be encapsulated, only becoming active in their properties upon rupture of the capsule by a puncture-type process. Such would provide for the normal characteristics of the article to be maintained up to that point where a puncture then takes place.

The concentrations of the colloidal particulates used in said shear thickening fluid formulations are preferably tailored so as to prevent providing resistance to conventional movements associated with general use of the article during a surgical procedure, such as normal hand movements in the case of a glove, the shear thickening fluid undergoing an increase in viscosity upon application of a suitable shearing force equal in intensity to that associated with a puncturing process or action. As the properties of a shear thickening fluid can vary with concentration of particulate material it is important that the concentration of particulate does not vary. To ensure that the concentration of the STF does not change in normal use it is important that the fluid dispersing media is of low volatility being essentially non volatile so as to maintain the effective concentration of particulate matter. It is also preferred that the media does not interact with other fluids present in normal use. For example when aqueous media is commonly present in use it is important that the STF does not exhibit hygroscopic characteristics. In the case where the article has the function of forming a barrier to the passage of aqueous organic matter as in the case for a surgical glove, a hydrophobic STF can be used to ensure that the barrier properties of the composite are maintained. When a membrane is used to encapsulate the STF between an outer and inner of the articles it is preferred that the membrane forms a barrier to other fluids commonly found in use of the article. Therefore it is important that fluid cannot pass the membrane, either from the STF or that other fluids cannot enter the article hence changing the overall particulate concentration in the STF.

The shear thickening fluid may either be applied or encompassed within specific areas of the article construction, in particular those areas of the article prone to puncture, e.g. finger tips, palms etc in the case of a glove.

In one particularly preferred application, the article is a surgical glove, but as indicated above, other articles are also possible, including, but not limited to surgical gowns. Shear thickening fluids would be incorporated within gown construction in accordance with the invention for identical reasons as those outlined above.

The STF may be formed on form or be associated with the gown via any of the following outlined routes:
Gowns formed from natural/synthetic materials conventionally used for gown manufacture, whereby the gown construction material has been impregnated with the shear-thickening fluid.
Applied to the interior surface of the gown
Applied to the exterior surface of the gown
Applied to both surfaces of the gown
Provided on the surface of the main body of the gown only
Provided on all internal and external surfaces of the gown

Either via the methods of addition as described or via impregnation, shear thickening fluids may be used with gowns formed from either fibrous material, non fibrous material as well as blends thereof in nature. Alternatively, such fibres as those conventionally used in gown construction may also be interwoven with ballistic resistant material fibres.

The present invention is also applicable to wound-care products, including wound dressings and support bandages and products of that type etc, in order to provide protection from further injury at the point of occlusion or, alternatively, to provide localised and functional support to the area local to which the support bandage was applied for the purpose of, for example, providing support on the generation of movement by the user, whilst not providing support to said area when said area is static and hence providing a reduced opportunity for constriction of blood flow as a result of the support being needlessly provided on a permanent basis whilst the dressing was worn. More particularly, the shear thickening fluid contained as part of the structure or within the structure of the bandage would remain at low viscosity until physical movement occurred, thus causing the viscosity of the shear thickening fluid to increase, rigidizing the bandage and providing functional support and protection. Conversely, on cessation of said movement, the viscosity of the shear thickening fluid would return to its former state.

The present invention thereby further provides a medical support structure which includes at least regions containing shear thickening fluid, said shear thickening fluid, upon movement of structure in use due to movement of a part to which it is attached, increasing in viscosity in order to increase the rigidity of the structure and hence increase support to the part during said movement.

With respect to such products, the shear thickening fluid may be impregnated into single layers of ballistic resistant material incorporated within the device structure. Alternatively, the shear thickening fluids may be impregnated within conventional woven/non-woven natural and synthetic material from which such articles are typically constructed. Alternatively the shear thickening fluids may be contained between layers of said fibres in the form of a gel.

1. A surgical garment or material including a shear thickening fluid which operates to inhibit penetration of the garment or material.

2. A surgical garment according to claim 1 in the form of one of a surgical gown, a surgical glove, and a surgical mask.

3. A surgical garment or material according to claim 1, wherein the shear thickening fluid forms a layer on at least one of the inner and outer surfaces of the garment or material.

4. A surgical garment or material according to claim 1, wherein the shear thickening fluid forms an intermediate layer between inner and outer surfaces of the garment or material

5. A surgical garment or material according to claim 1, wherein the garment or material includes a layer of ballistic resistant material which is impregnated with the shear thickening fluid.

6. A surgical garment or material according to claim 1, wherein the shear thickening fluid is dispersed with individual fibres of ballistic resistant material.

7. A surgical garment or material according to claim 1, wherein the shear thickening fluid includes a colorant material which provides a visual indication when the garment or material has been penetrated.

8. A surgical garment or material according to claim 1, wherein shear thickening fluid is present in the form of one of a solution, a gel and in encapsulated form.

9. A surgical garment or material according to claim 1, wherein the shear thickening fluid is present only in specific areas of the garment or material which, in use, are more susceptible to puncture.

10. A surgical garment or material according to claim 1, wherein shear thickening fluid in which the fluid/article is at least one of Hydrophobic, Non hygroscopic, and contained within an impermeable membrane.

11. A medical support structure which includes at least one region of shear thickening fluid, which, upon movement of the support structure during use due to movement of a part to which it is attached, increases in viscosity in order to increase the rigidity of the structure and hence increase support to the part during said movement.

12. A method of making a surgical garment or material according to claim 1, wherein the shear thickening fluid is incorporated onto or into the garment or material by one of dipping the fully formed garment or material in shear thickening fluid, dipping the garment or material in shear thickening fluid at an intermediate stage of manufacture, applying, e.g. spraying the shear thickening fluid onto at least one of the inner and outer surface of the fully formed garment or material, and applying or spraying the shear thickening fluid at an intermediate stage of manufacture so as to form an intermediate layer in the finished garment or material.

13. A medical support structure according to claim 11, wherein the shear thickening fluid is incorporated onto or into the garment or material by one of dipping the fully formed garment or material in shear thickening fluid, dipping the garment or material in shear thickening fluid at an intermediate stage of manufacture, applying or spraying the shear thickening fluid onto at least one of the inner and outer surface of the fully formed garment or material, or applying or spraying the shear thickening fluid at an intermediate stage of manufacture so as to form an intermediate layer in the finished garment or material.
